(19) United States
(12) Patent Application Publication
(10) Pub. No.: US 2002/0084250 A1
(43) Pub. Date: Jul. 4, 2002

(54) Method for forming a passivation on berry diffusion layer of a non-volatile memory

(76) Inventor: Ching-Yu Chang, Yilan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/752,432

(22) Filed: Jan. 3, 2001

(51) Int. Cl. B44C 1/22

(52) U.S. Cl. 216/41

(57) ABSTRACT

The present invention provides a method for forming a passivation on the berry diffusion layer of a non-volatile memory. A silicon substrate having a patterned photo resist thereon is first provided. A plurality of berry diffusion regions are formed at positions not covered by the photo resist in the silicon substrate by means of ion implantation or etching. A covering layer is deposited on the silicon substrate. The covering layer is then etched to expose the photo resist. Next, the photo resist is removed by means of selective etching so that a self-aligned passivation can be formed on the berry diffusion implanted or etched regions. The present invention provides a method of simpler procedure for forming a self-aligned protection.

### FIELD OF THE INVENTION

The present invention relates to a method for forming a passivation on the berry diffusion layer of a non-volatile memory and, more particularly, to a method for forming a self-aligned passivation on the berry diffusion layer of a mask read only memory (MROM).

### BACKGROUND OF THE INVENTION

The mask read only memory (PROM) is the most basic read only memory. The MROM is fabricated through a plurality of cycles of three main procedures: deposition, photolithography, and etching. During the photolithography procedure, patterns on a photo mask are completely transferred to a photo resist on the surface of a silicon substrate so that a patterned photo resist can be formed on the silicon substrate to facilitate subsequent procedures such as etching or ion implantation.

As shown in FIG. 1, a patterned photo resist 12 is formed on a silicon substrate 10. With a subsequent ion implantation procedure as an example, a plurality of diffusion regions 14 are formed at positions not covered by the photo resist 12 on the silicon substrate 10. Next, the patterned photo resist 12 is removed, and a silicon dioxide (SiO₂) layer 16 is deposited on the surface of the silicon substrate 10. A patterned photo resist 18 corresponding to the positions of the diffusion regions 14 is then formed on the SiO₂ layer 16. The SiO₂ layer 16 not covered by the photo resist 18 is removed by etching. Finally, the patterned photo resist 18 is removed so that the remained SiO₂ layer 16′ can cover the diffusion regions 14 to provide protection.

However, in the above fabrication process, when the patterned photo resist 18 is formed on the SiO₂ layer, the photo resist 18 cannot exactly align with the diffusion regions 14 due to the problem in the photolithography technique or other factors. Therefore, the remained SiO₂ layer 16′ after etching cannot align with the diffusion regions 14. In other words, the remained SiO₂ layer 16′ cannot completely cover the diffusion regions 14 to provide full protection, detrimental to the proceeding of subsequent procedures. Damages to the silicon substrate may thus easily arise. Additionally, the above process is more cumbersome, not conforming to the present requirement of simplified process.

Accordingly, the present invention aims to provide a method of simpler process for forming a self-aligned passivation on the diffusion regions to resolve the above problems.

### SUMMARY OF THE INVENTION

The primary object of the present invention is to provide a method for forming a self-aligned passivation on the berry diffusion layer of a MROM after the photolithography procedure so that the self-aligned passivation can fully cover the diffusion regions to protect them from influences of other fabrication procedures.

Another object of the present invention is to provide a method of simpler process for forming a passivation on the diffusion regions.

According to the present invention, a berry diffusion layer is formed by means of ion implantation or etching on a silicon substrate having a patterned photo resist. A covering layer is deposited on the silicon substrate. The covering layer is then etched to expose the photo resist. Next, the photo resist is removed so that a self-aligned passivation can be formed on the berry diffusion layer.

### BRIEF DESCRIPTION OF THE DRAWINGS

FIG. 1 is a flowchart of forming a passivation on the berry diffusion layer according to the prior art;

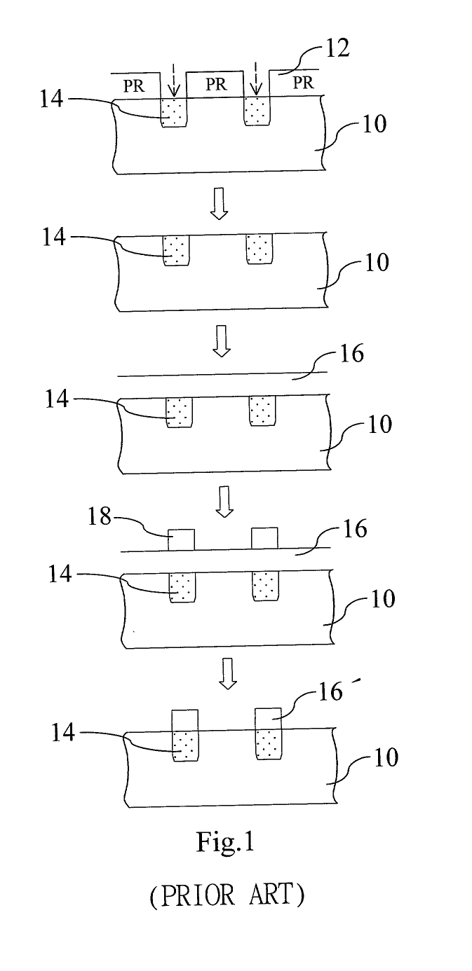

FIG. 2 is a flowchart of forming a passivation in the ion implantation procedure according to the present invention; and

FIG. 3 is a flowchart of forming a passivation in the etching procedure according to the present invention.

### DETAILED DESCRIPTION OF THE PREFERRED EMBODIMENTS

The present invention is characterized in that a self-aligned passivation is formed on the berry diffusion (briefly termed as BD) layer. The characteristics of the present invention will be illustrated below through the help of subsequent procedures of ion implantation and etching, respectively.

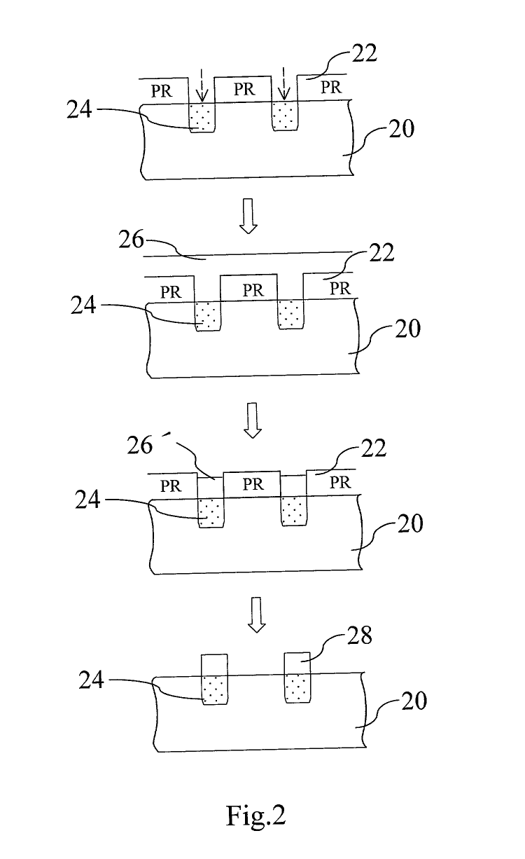

FIG. 2 shows a method of forming a passivation in the subsequent procedure of ion implantation. A silicon substrate 20 having a patterned photo resist 22 thereon is first provided. A plurality of BD implanted regions 24 are formed at positions not covered by the photo resist 22 on the silicon substrate 20 by means of ion implantation. A covering layer 26 is then deposited directly on the silicon substrate 20 to fully cover the photo resist 22 and to fill the BD implanted regions 24 not covered by the photo resist 22. Next, the covering layer 26 is etched to expose the photo resist 22. At this time, the remained covering layer 26′ is still reserved on the BD implanted regions 24 not covered by the photo resist 22. Finally, the photo resist 22 is removed to form a self-aligned passivation 28 so that the passivation 28 can fully cover the BD implanted regions 24, providing a full protection.

The above methods for forming a self-aligned passivation are similar. That is, the BD implanted regions are first formed at positions not covered by a patterned photo resist on the silicon substrate by means of ion implantation and a passivation is then formed. Thereby, the passivation can self align with the BD implanted regions exactly to achieve the effect of fill protection. The drawback of misalignment of the passivation in prior art can be effectively overcome.

The above patterned photo resist is formed by illuminating a deep UV light through a photo mask. The sacrificial layer of this kind of photo resist of deep UV light can be replaced with other material such as oxide, spin-on glass (SOG), boron-phosphorous-silicon glass (BPSG), and silicon nitride. The material of the above covering layer can comprise oxide, nitride, SOG, or BPSG.

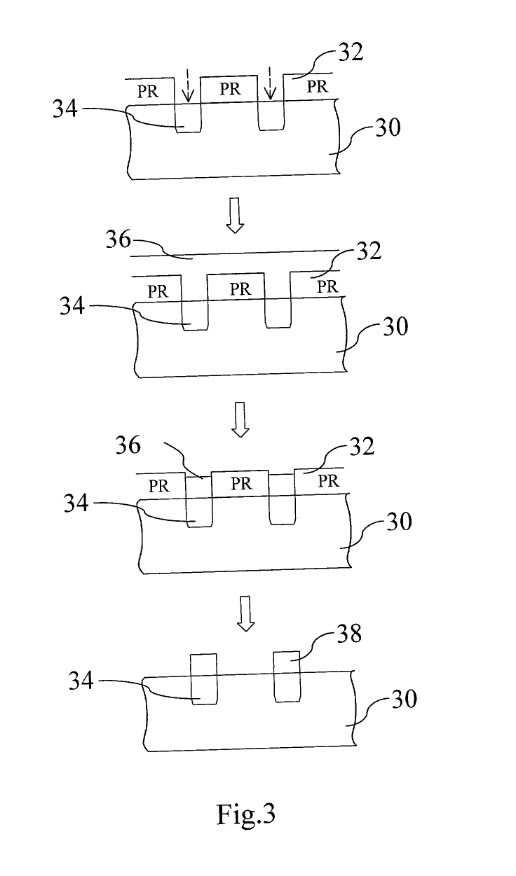

FIG. 3 shows a method of forming a passivation in the subsequent procedure of etching. A silicon substrate 30 having a patterned photo resist 32 thereon is first provided. A plurality of BD etched regions 34 are formed at positions not covered by the photo resist 32 on the silicon substrate 30 by means of etching. A covering layer 36 is then deposited directly on the silicon substrate 30 to fully cover the photo resist 32 and to fill the BD etched regions 34 not covered by the photo resist 32. Next, the covering layer 36 is etched to expose the photo resist 32. The remained covering layer 36′ self-aligns with and covers the BD etched regions 34. Finally, the photo resist 32 is removed to form a self-aligned passivation 38 so that the passivation 38 can fully cover the BD etched regions 34, thereby providing a full protection.

The above photo resist isolation layer covering the substrate can be replaced with an isolation layer composed of materials such as oxide, silicon nitride, boron, phosphorous, or BPSG. The material of the above covering layer and the principle of self-alignment are the same as above and thus will not be further described.

After the photolithography procedure, no matter the procedure of ion implantation or the procedure of etching, the present invention can form a self-aligned passivation on the BD layer of a MROM so that the passivation can fully cover the BD layer, protecting the BD layer from influences of other procedures. Moreover, the present invention simplifies the whole procedure of forming the passivation. In other words, the present invention provides a method of simpler procedure for forming a passivation on the BD layer.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method for forming a passivation on the diffusion layer of a non-volatile memory, comprising the steps of:
providing a substrate having a patterned sacrificial layer thereon;
forming a plurality of berry diffusion regions at positions not covered by said sacrificial layer in said substrate by means of ion implantation;
depositing a covering layer on said substrate to fully cover said sacrificial layer;
etching said covering layer to expose said sacrificial layer; and
removing said sacrificial layer by means of selective etching so that the remained covering layer respectively covers said berry diffusion regions to form a self-aligned passivation.

2. The method as claimed in claim 1, wherein said substrate is a silicon substrate.

3. The method as claimed in claim 1, wherein said sacrificial layer can be selected among the group comprising photo resist of deep UV light, oxide, spin-on glass, boron-phosphorous-silicon glass, and silicon nitride.

4. The method as claimed in claim 1, wherein the material of said covering layer can be selected among the group comprising oxide, nitride, spin-on glass, and boron-phosphorous-silicon glass.

5. A method of forming a self-aligned passivation, comprising the steps of:
providing a substrate having a patterned isolation layer thereon;
performing a process at positions not covered by said isolation layer on said substrate;
depositing a covering layer on said substrate to fully cover said isolation layer;
etching said covering layer to expose said isolation layer; and
removing said isolation layer by means of selective etching so that the remained covering layer respectively covers said processed regions to form a self-aligned passivation.

6. The method as claimed in claim 5, wherein said substrate is a silicon substrate.

7. The method as claimed in claim 5, wherein said isolation layer can be selected among the group comprising patterned oxide, photo resist, silicon nitride, boron, phosphorous, and boron-phosphorous-silicon glass.

8. The method as claimed in claim 5, wherein the material of said covering layer can be selected among the group comprising nitride, oxide, spin-on glass, and boron-phosphorous-silicon glass.
